(19) United States
(12) Patent Application Publication
(10) Pub. No.: US 2010/0002131 A1
(43) Pub. Date: Jan. 7, 2010

(54) FLICKER REDUCTION FOR 2-DIMENSIONAL DE-INTERLACING

(76) Inventor: YING-RU CHEN, Tainan (TW)

Correspondence Address: STOUT, UXA, BUYAN & MULLINS LLP, 4 VENTURE, SUITE 300, IRVINE, CA, 92618, US

(21) Appl. No.: 12/167,914

(22) Filed: Jul. 3, 2008

(51) Int. Cl. H04N 7/01

(52) U.S. Cl. 348/448; 348/E07.003

(57) ABSTRACT

A method and apparatus of de-interlacing are disclosed. A flicker bit is assigned to each line of a frame to indicate a flicker characteristic of each line. A de-interlaced line is then generated by duplicating a neighboring scan line in a current frame according to an active flicker bit of a previous frame.

### BACKGROUND OF THE INVENTION

1. Field of the Invention

The present invention generally relates to de-interlacing, and more particularly to flicker reduction for 2-dimensional de-interlacing.

2. Description of the Prior Art

Most broadcasting television signals, such as NTSC, PAL or SECOM, are interlaced to display odd-field and even-field in turn, which are perceived as a whole frame due to persistence of vision. Interlaced video signals could be satisfactorily broadcast without consuming much bandwidth, but disadvantageously have reduced vertical resolution, line or area flicker. The video signals for computer displays, on the other hand, are non-interlaced or progressive to directly display the whole frame on the display.

In order to display the interlaced video signals on a progressive-type display, such as a computer display, the interlaced video signals should be transformed into non-interlaced or progressive video signals through a de-interlacing or line doubling process. Through the de-interlacing, the original odd-field and even-field are combined into a frame.

Video signals are conventionally de-interlaced through spatial or temporal transformation. In the temporal transformation (also known as 3-dimensional or inter-field de-interlacing), pixels or scan lines in neighboring fields are used to generate new pixel/scan lines respectively. A stable de-interlaced video could be attained by 3-dimensional de-interlacing, however, at the cost of involving substantial buffers for temporarily storing neighboring previous and subsequent fields. In the spatial transformation (also known as 2-dimensional or intra-field transformation), pixels or scan lines in the same field are used to generate or insert new pixel/scan lines. There is no need for the buffers in the 2-dimensional de-interlacing, but the de-interlaced video likely possesses instability, such as may be manifested, for example, with unsatisfactory flickering or toggling (flicker or toggle), particularly along a horizontal line.

FIG. 1 illustrates a schematic of exemplary frames with flicker. In this simplified example, the original frame has six lines, among which the third line (3) and the fourth line (4) are black. The original frame is interlaced into a frame 1 (odd-field) and a frame 2 (even-field) as shown. Subsequently, the frame 1 and the frame 2 are de-interlaced in turn, so that the de-interlaced frames can be displayed on a progressive display. With respect to frame 1, a de-interlaced line (2) is generated, for example, by averaging the first line (1) and the third line (3), and the resultant de-interlaced line (2) is grey. In a similar manner, another de-interlaced line (4) with grey color is also generated. With respect to the frame 2, a grey de-interlaced line (3) and a grey de-interlaced line (5) are also generated. While the de-interlaced frame 1 and frame 2 are displayed in sequence on the progressive display, a viewer will perceive a flicker caused by the toggling of a single black line in each frame, rather than seeing two contiguous black lines.

Accordingly, a need has arisen for a novel de-interlacing that not only benefits from the simplicity of 2-dimensional de-interlacing, but also attains stable de-interlaced video without flicker or toggle.

### SUMMARY OF THE INVENTION

In view of the foregoing, it is an object of the present invention to provide a 2-dimensional de-interlacing method and apparatus for attaining a stable de-interlaced video without flicker or toggle.

According to the object, the present invention provides a method and apparatus of de-interlacing. A flicker bit is assigned to each line of a frame to indicate a flicker of each line. A de-interlaced line is then generated by duplicating a neighboring scan line in a current frame according to the active flicker bit of a previous frame. In one embodiment, brightness values of each pair of corresponding pixels of the neighboring scan line in the current frame are compared; a flicker pixel is designated when the comparing difference is greater than a predetermined threshold value; and the flicker pixel determines whether it is sufficiently real. If it is, a neighboring scan line in the current frame is duplicated to generate the de-interlaced line.

### BRIEF DESCRIPTION OF THE DRAWINGS

FIG. 1 illustrates a schematic of exemplary frames with flicker;

FIG. 2A illustrates a flow diagram of a 2-dimensional de-interlacing method and apparatus according to one embodiment of the present invention;

FIG. 2B illustrates a detailed flow diagram of the block 12 of FIG. 2A;

FIG. 2C illustrates a detailed flow diagram of the block 16 of FIG. 2A;

FIG. 3A shows exemplary and simplified frames illustrating the de-interlacing in progress according to the flow diagram of FIG. 2A; and

FIG. 3B illustrates a partial schematic of the exemplary current frame in FIG. 3A.

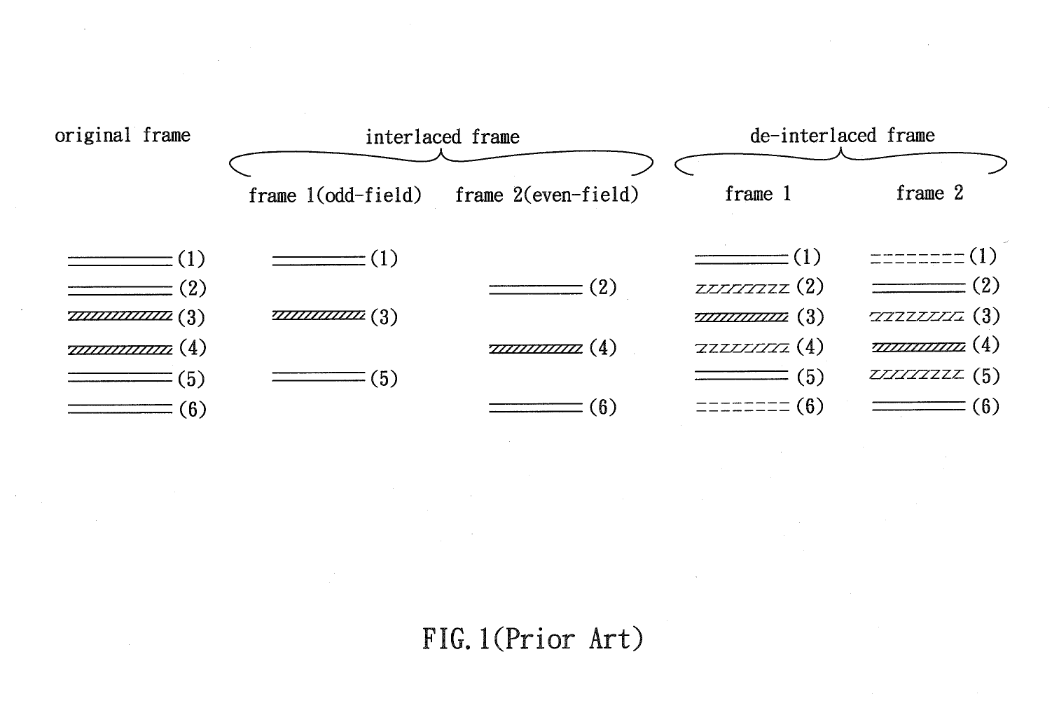

### DETAILED DESCRIPTION OF THE INVENTION

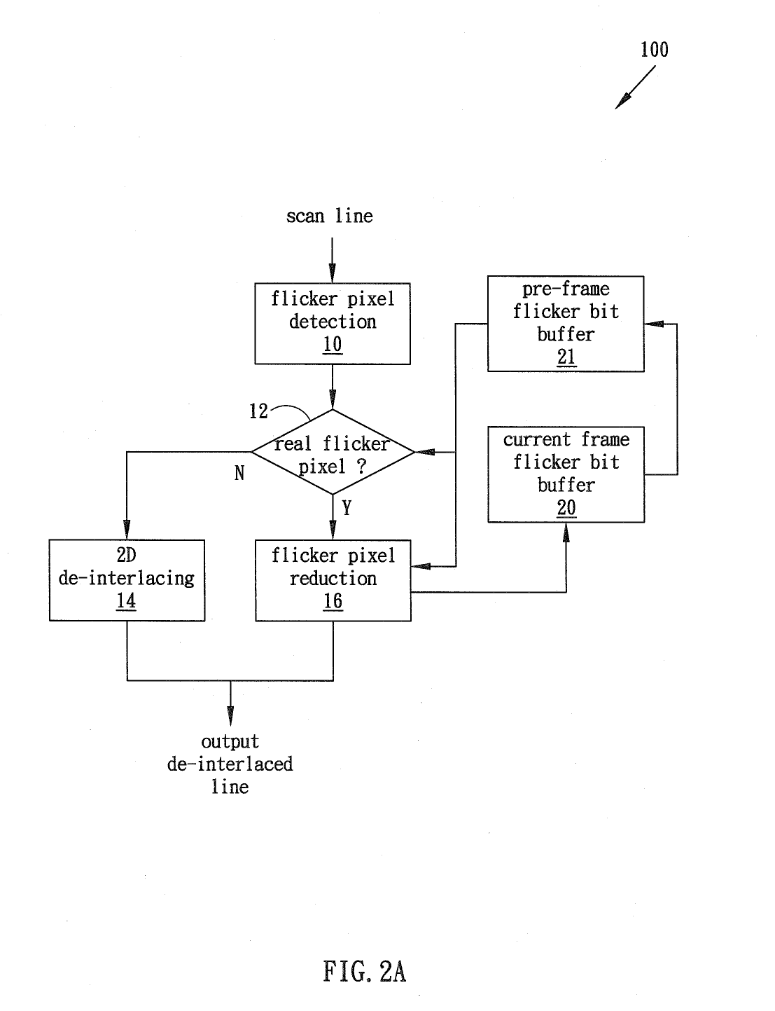

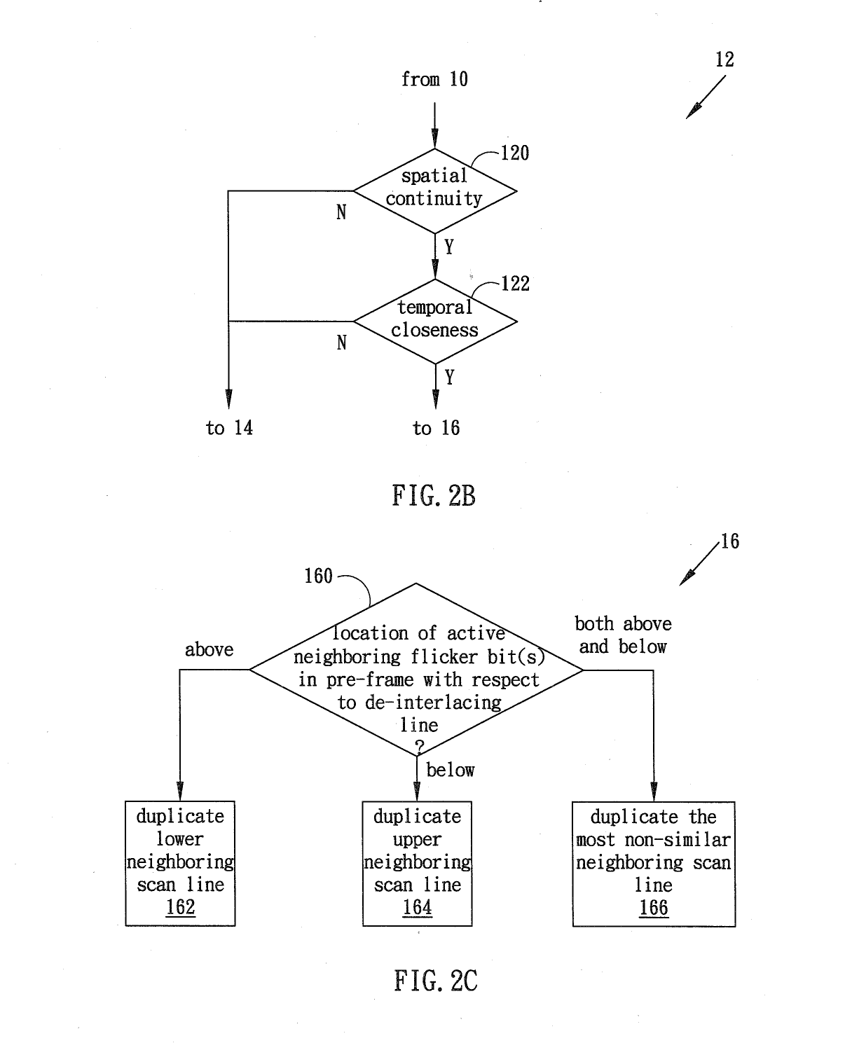

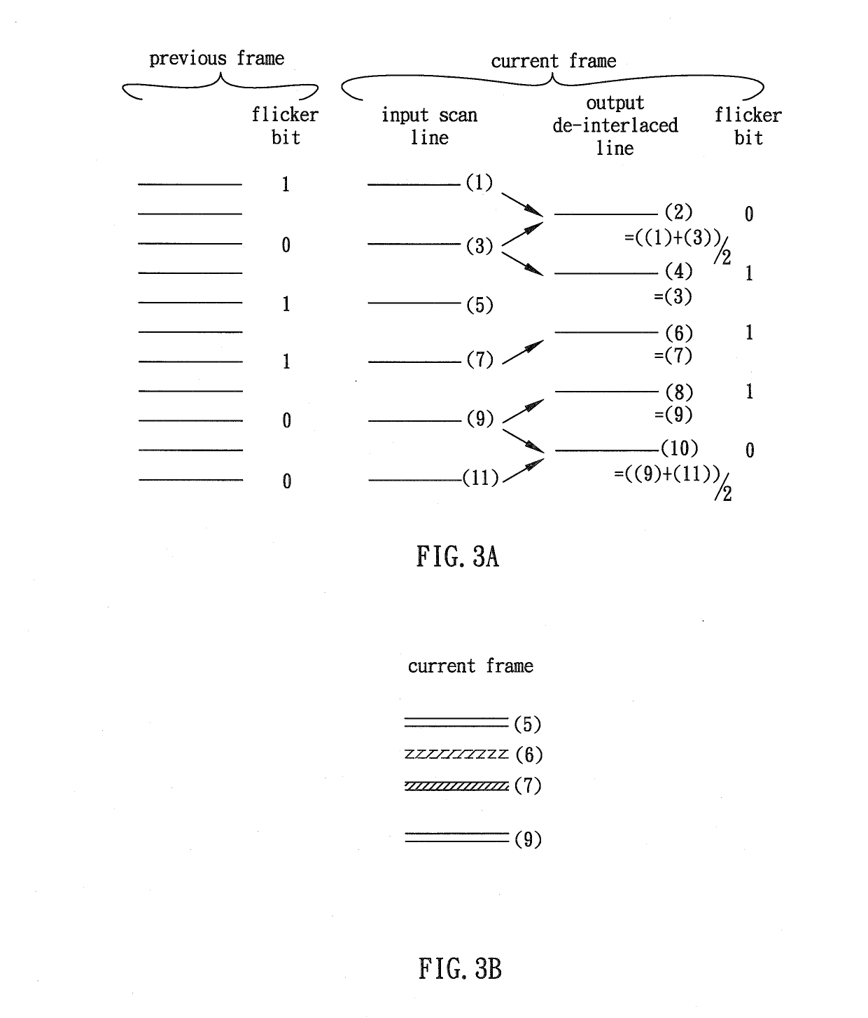

FIG. 2A illustrates a flow diagram of a 2-dimensional de-interlacing method and apparatus 100 according to one embodiment of the present invention. Each block of the flow diagram 100 may represent a step or a device, and can be implemented either in hardware, software or their combination. FIG. 3A shows exemplary and simplified frames illustrating the de-interlacing in progress according to the flow diagram of FIG. 2A.

First of all, scan lines of a current frame are inputted. For example, in FIG. 3A, scan lines (1) and (3) of an odd field in the current frame are inputted, and a de-interlaced line (2) between the scan lines (1) and (3) is accordingly generated. The scan lines (1) and (3) are subjected to flicker pixel detection (in block 10) to determine flicker pixel or pixels. In the illustrated embodiment, brightness values of each pair of corresponding pixels of the scan lines (1) and (3) are compared. A flicker pixel is designated when the comparing difference is greater than a predetermined threshold value; otherwise a non-flicker pixel is designated.

Subsequently, in block 12, the flicker pixels are subjected to further determination to decide whether the flicker pixels are sufficient to be real (or adequate) flicker pixels. In this embodiment, the sufficiency or adequacy of the real flicker pixels is determined according to the flow diagram in FIG. 2B. First, spatial continuity (block 120) is determined to check whether the flicker pixels are continuous spatially in the same line. Subsequently, temporal closeness (or similarity) (block 122) is determined to check whether at least one neighboring line in the previous frame is a flicker line. For example, in FIG. 3A, a neighboring line (1) in the previous frame is a flicker line (with the active flicker bit “1”) with respect to the line (2) in the current frame. On the contrary, for example, neither neighboring line (9) nor line (11) in the previous frame is a flicker line with respect to the line (10) in the current frame.

Returning to FIG. 2A, when no real flicker pixel is determined (following the “N” branch of the block 12), the de-interlacing is then performed according to conventional 2-dimensional de-interlacing method (block 14), such as, but not limited to, an interpolation by averaging two neighboring scan lines to generate the de-interlaced line. For example, in FIG. 3A, as no real flicker pixels are determined with respect to the line (10) in the current frame, a conventional 2-dimensional de-interlacing method is employed to generate a de-interlaced line (10) by averaging two neighboring scan lines (9) and (11) (that is, line(10)=(line(9)+line(11))/2).

Still referring to FIG. 2A, when a real flicker pixel is determined (following the “Y” branch of the block 12), the de-interlacing is performed according to a flicker pixel reduction method (block 16) of the present invention, which is illustrated in the exemplary implementation of FIG. 2C. In the embodiment, the location of the neighboring active flicker bit or bits in the previous frame with respect to the line to be de-interlaced in the current frame is firstly determined in block 160. When the answer is “above,” the de-interlaced line is then generated by duplicating its lower neighboring scan line in the current frame (block 162). For example, in FIG. 3A, with respect to the line (8) in the current frame, there is a neighboring active flicker bit in the previous frame located above the current line (8), and, accordingly, the de-interlaced line (8) in the current frame is generated by duplicating its lower neighboring scan line (9) (that is, line(8)=line(9)). Alternatively, when the answer to the block 160 (FIG. 2C) is “below,” the de-interlaced line is then generated by duplicating its upper neighboring scan line in the current frame (block 164). For example, in FIG. 3A, with respect to the line (4) in the current frame, there is a neighboring active flicker bit in the previous frame located below the current line (4), and, accordingly, the de-interlaced line (4) in the current frame is generated by duplicating its upper neighboring scan line (3) (that is, line(4)=line(3)). On the other hand, when the answer to the block 160 (FIG. 2C) is “both above and below,” the de-interlaced line is generated by duplicating a neighboring scan line in the current frame that is most non-similar among the neighboring scan lines (block 166). For example, in FIG. 3A, with respect to the line (6) in the current frame, there are neighboring active flicker bits in the previous frame located both above and below the current line (6). FIG. 3B illustrates a partial schematic of the exemplary current frame in FIG. 3A. In the figure, black line (7) is the most non-similar among the neighboring white line (5), back line (7) and white line (9), and therefore the de-interlaced line (6) is generated by duplicating the scan line (7) (that is, line(6)=line(7)).

In the case of real flicker pixels, if the ratio of the real flicker pixels to the totals pixels in a line is greater than a predetermined value (for example, 25%), the corresponding line in the current frame is determined as a flicker line, and is denoted by an active flicker bit (for example, bit “1”) and is stored in a current flicker bit buffer 20. Otherwise, the line is determined as a non-flicker line, and is denoted by an inactive flicker bit (for example, bit “0”) in the current flicker bit buffer 20. Each line of a frame has a corresponding flicker bit. In the flow diagram 100 (FIG. 2A), the current flicker bit buffer 20 is used to store the flicker bits of, for example, odd scan lines in the current frame, and a pre-frame flicker bit buffer 21 is used to store the flicker bits of even scan lines in the previous frame. At the end of the de-interlacing of each current frame, the content of the current flicker bit buffer 20 overwrites the pre-frame flicker bit buffer 21, followed by resetting the current flicker bit buffer 20 for storing flicker bits of a next frame.

The blocks 10-16 discussed above are sequentially performed to generate each de-interlaced line in sequence. According to the embodiment of the present invention, the resultant de-interlaced video as a whole would be stable without flicker or toggle, particularly along a horizontal line, compared to the result of conventional 2-dimensional de-interlacing method.

Although specific embodiments have been illustrated and described, it will be appreciated by those skilled in the art that various modifications may be made without departing from the scope of the present invention, which is intended to be limited solely by the appended claims.

What is claimed is:

1. A method of de-interlacing, comprising:
assigning a flicker bit to each line of a frame to indicate a flicker of each line; and
generating a de-interlaced line by duplicating a neighboring scan line in a current frame according to an active flicker bit of a previous frame.

2. The method according to claim 1, wherein before performing said step of generating the de-interlaced line, the method further comprises:
comparing brightness values of each pair of corresponding pixels of the neighboring scan line in the current frame;
designating a flicker pixel when the comparing difference is greater than a predetermined threshold value; and
determining whether the flicker pixel is a sufficiently real flicker pixel.

3. The method according to claim 2, wherein sufficiency of the real flicker pixel is determined by:
determining whether the flicker pixels are continuous spatially in the same line; and
determining whether there is at least one neighboring line in the previous frame with the active flicker bit.

4. The method according to claim 3, wherein said step of duplicating the neighboring scan line in the current frame comprises:
generating the de-interlaced line by duplicating a lower neighboring scan line in the current frame, when the neighboring line in the previous frame with the active flicker bit is located above the de-interlaced line in the current frame;
generating the de-interlaced line by duplicating an upper neighboring scan line in the current frame, when the neighboring line in the previous frame with the active flicker bit is located below the de-interlaced line in the current frame; and
generating the de-interlaced line by duplicating the neighboring scan line in the current frame that is most non-similar among the neighboring scan lines, when the neighboring lines in the previous frame with the active flicker bit are located both above and below the de-interlaced line in the current frame.

5. The method according to claim 2, further comprising:
generating the de-interlaced line by interpolation when the flicker pixel is not the sufficiently real flicker pixel.

6. The method according to claim 1, further comprising assigning the flicker bit to each line of the frame in a buffer.

7. The method according to claim 2, wherein said flicker bit of a line of the frame is active when a ratio of the real flicker pixels to totals pixels in the line is greater than a predetermined value.

8. An apparatus for de-interlacing, comprising:
means for assigning a flicker bit to each line of a frame to indicate a flicker characteristic of each line; and
means for generating a de-interlaced line by duplicating a neighboring scan line in a current frame according to an active flicker bit of a previous frame.

9. The apparatus according to claim 8, further comprising:
means for comparing, before generating the de-interlaced line, brightness values of each pair of corresponding pixels of the neighboring scan line in the current frame;
means for designating a flicker pixel when the comparing difference is greater than a predetermined threshold value; and
means for determining whether the flicker pixel is a sufficiently real flicker pixel.

10. The apparatus according to claim 9, wherein sufficiency of the real flicker pixel is determined by:
determining whether the flicker pixels are continuous spatially in the same line; and
determining whether there is at least one neighboring line in the previous frame with the active flicker bit.

11. The apparatus according to claim 10, wherein said means for generating a de-interlaced line comprises:
means for generating the de-interlaced line by duplicating a lower neighboring scan line in the current frame, when the neighboring line in the previous frame with the active flicker bit is located above the de-interlaced line in the current frame;
means for generating the de-interlaced line by duplicating an upper neighboring scan line in the current frame, when the neighboring line in the previous frame with the active flicker bit is located below the de-interlaced line in the current frame; and
means for generating the de-interlaced line by duplicating the neighboring scan line in the current frame that is most non-similar among the neighboring scan lines, when the neighboring lines in the previous frame with the active flicker bit are located both above and below the de-interlaced line in the current frame.

12. The apparatus according to claim 9, further comprising:
means for generating the de-interlaced line by interpolation when the flicker pixel is not the sufficiently real flicker pixel.

13. The apparatus according to claim 8, further comprising a buffer for assigning the flicker bit to each line of the frame.

14. The apparatus according to claim 9, wherein said flicker bit of a line of the frame is active when a ratio of the real flicker pixels to totals pixels in the line is greater than a predetermined value.
